(19) United States
(12) Patent Application Publication
(10) Pub. No.: US 2002/0169721 A1
(43) Pub. Date: Nov. 14, 2002

(54) Digital watermarking apparatus, systems and methods

(76) Inventors: William Ray Cooley, Tulsa, OK (US); Phillip Andrew Seder, Portland, OR (US)

Correspondence Address: DIGIMARC CORPORATION, 19801 SW 72ND AVENUE, SUITE 100, TUALATIN, OR, 97062, US

(21) Appl. No.: 09/853,835

(22) Filed: May 10, 2001

(51) Int. Cl. G06F 17/60

(52) U.S. Cl. 705/51

(57) ABSTRACT

A variety of systems responsive to watermarked documents are detailed. In one, a system includes a user terminal, a central site, and a website. The user terminal includes a watermark reader, and a capture device to capture an image of a watermarked document. The central site includes a database of watermark identifiers and corresponding and related information. The user terminal communicates an extracted watermark identifier to the central site. The central site interrogates a database via the extracted watermark identifier to find any related information. The central site generates a random number and a time stamp, and stores such as a verification record along with the extracted watermark identifier. Such a verification record can be used to verify authority to enter the website from the user terminal.

### RELATED APPLICATION DATA

This application is related to U.S. patent application Ser. No. 09/562,049, filed May 1, 2000, and Ser. No. 09/790,322, filed Feb. 21, 2001. This application is also related to PCT Application No. ______, filed in the United States Receiving Office on Apr. 30, 2001, entitled “Digital Watermarking Systems” (Attorney Docket No. P0364).

### FIELD OF THE INVENTION

The present invention relates to digital watermarking systems and methods, and is particularly illustrated with reference to a verification system and method.

### BACKGROUND AND SUMMARY OF THE INVENTION

Digital watermarking technology, a form of steganography, encompasses a great variety of techniques by which plural bits of digital data are hidden in some other object without leaving human-apparent evidence of alteration.

Digital watermarking may be used to modify media content to embed a machine-readable code into the data content. The data may be modified such that the embedded code is imperceptible or nearly imperceptible to the user, yet may be detected through an automated detection process.

Most commonly, digital watermarking is applied to media such as images, audio signals, and video signals. However, it may also be applied to other types of data, including documents (e.g., through line, word or character shifting, through texturing, graphics, or backgrounds, etc.), software, multi-dimensional graphics models, and surface textures of objects.

Digital watermarking techniques can also be applied to traditional physical objects, including blank paper. Such blank media, however, presents certain challenges since there is no image that can serve as the carrier for the watermark signal.

The surface of a paper or other physical object can be textured with a pattern of micro-indentations to steganographically encode plural-bit information. The texturing is optically discernible, e.g., by a scanner, permitting the digital data to be decoded from scan data corresponding to the paper object.

There are other processes by which media can be processed to encode a digital watermark. Some techniques employ very subtle printing, e.g., of fine lines or dots, which has the effect slightly tinting the media (e.g., a white media can be given a lightish-green cast). To the human observer the tinting appears uniform. Computer analyses of scan data from the media, however, reveals slight localized changes, permitting the multi-bit watermark payload to be discerned. Such printing can be by ink jet, dry offset, wet offset, xerography, etc.

Other techniques extend the texturing techniques, e.g., by employing an intaglio press to texture the media as part of the printing process (either without ink, or with clear ink).

The encoding of a document can encompass artwork or printing on the document, the document's background, a laminate layer applied to the document, surface texture, etc. If a photograph or image is present, it too can be encoded.

Printable media—especially for security documents (e.g., banknotes) and identity documents (e.g., passports)—is increasingly fashioned from synthetic materials. Polymeric films, such as are available from UCB Films, PLC of Belgium, are one example. Such films may be clear and require opacification prior to use as substrates for security documents. The opacification can be affected by applying plural layers of ink or other material, e.g., by gravure or offet printing processes. (Suitable inks are available, e.g., from Sicpa Securink Corp. of Springfield, Va.) In addition to obscuring the transparency of the film, the inks applied through the printing process form a layer that is well suited to fine-line printing by traditional intaglio methods. Such an arrangement is more particularly detailed in laid-open PCT publication WO98/33758.

Digital watermarking systems typically have two primary components: an embedding component that embeds the watermark in the media content, and a reading component that detects and reads the embedded watermark. The embedding component embeds a watermark pattern by altering data samples of the media content. The reading component analyzes content to detect whether a watermark pattern is present. In applications where the watermark encodes information, the reading component extracts this information from the detected watermark. Commonly assigned U.S. application Ser. No. 09/503,881, filed Feb. 14, 2000, discloses various encoding and decoding techniques. U.S. Pat. No. 5,862,260 discloses still others. Of course, artisans know many other watermark techniques that may be suitably interchanged with the present invention.

Embedded machine-readable code can be used to link to or otherwise identify related information. In one illustrative example, a document is embedded with an identifier (or machine readable code). The identifier is extracted by a watermark-reading device and is passed to a central server. The central server includes a database with related information. The related information is indexed via watermark identifiers. Such related information may include a URL, web address, IP address, and/or other information. The extracted identifier is used to interrogate the central server database to locate corresponding related information, such as a URL. The URL is passed from the central server to the reading device, which directs a web browser with the URL. Commonly assigned U.S. application Ser. No. 09/571,422, filed May 15, 2000, discloses applications and examples of such techniques.

An enhancement can be made to the above systems and methods. Consider an example where a URL points to confidential material, or to a privileged website (e.g., a website accessible through watermarked documents, secret, etc.). In this case, it is advantageous to restrict access to the corresponding website, allowing access to only those users having physical possession of a corresponding watermarked document. Accordingly, there is a need for a verification system for use with watermark-based (or identifier-based) routing to websites, files, databases, networks, computers, etc.

The foregoing and other features and advantages of the present invention will be more readily apparent from the following detailed description, which proceeds with reference to the accompanying drawings.

### BRIEF DESCRIPTION OF THE DRAWINGS

FIG. 1 shows a system according to an illustrative embodiment of the present invention.

FIG. 2 illustrates an alternate communications path for the FIG. 1 system.

FIGS. 3-6 are flow diagrams illustrating various methods and system functionality according to the present invention.

### DETAILED DESCRIPTION

System Overview

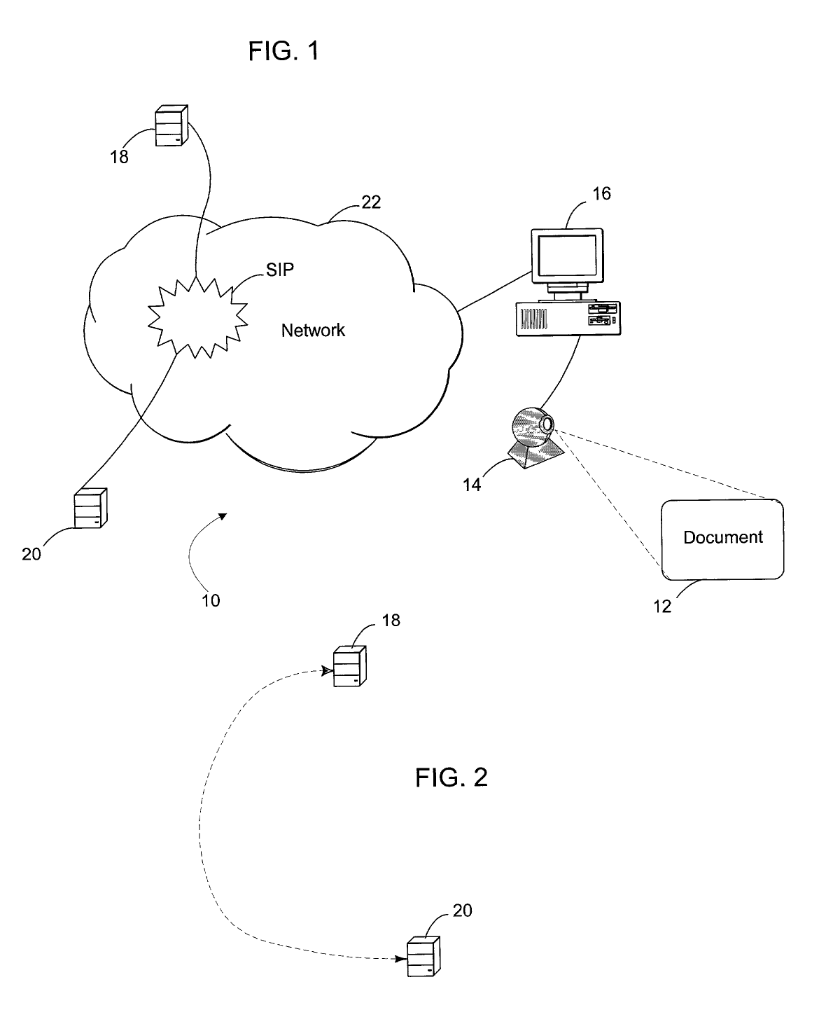

With reference to FIG. 1, a document 12 includes plural-bit digital data steganographically encoded therein (e.g., by digital watermarking). The document 12 can be a photo ID (e.g., a driver's license, student ID, identification card, or passport, etc.), a value document (e.g., a banknote, stock certificate, or other financial instrument), a trading card (e.g., baseball card, sports card, game card, character card, etc.), a magazine or newspaper article, advertisement, promotional, flier, stationary, envelope, letterhead, product package or label, candy wrapper, a credit card, a product manual, business card, bank or credit account card, printed document, picture, image, registration card, or virtually any other type of document. (In some embodiments, document 12 is a physical object such as a coffee cup, napkin, menu, soda pop can, jewelry, hardware, souvenir, etc.).

The encoding of the document 12 can encompass artwork or printing on the document 12, the document's background, a laminate layer applied to the document, surface texture, etc. If a photograph, graphic or image is present, it too can be encoded. A variety of watermark encoding techniques are detailed in the cited patent documents; artisans in the field know many more.

In an illustrative embodiment, document 12 is encoded with a payload, e.g., 2-256 bits. This payload is preferably processed before encoding, using known techniques (e.g., convolutional coding, turbo codes, etc.), to improve its reliable detection in adverse conditions. The payload preferably includes a document identifier. The document identifier may uniquely identify the document, or may identify a set of documents, or a subset of documents.

The encoded document 12 is presented to an input device 14 for image capture. The input device 14 can take various forms, including a flatbed scanner, a hand scanner (including an imaging mouse), a video camera, a digital camera, a web cam, a digital eye, optical sensor, image sensor, a CMOS or CCD sensor, etc. The input device 14 is in communication with terminal 16. Of course, instead of being tethered to terminal 16, as shown in FIG. 1, input device 14 may be in wireless communication (e.g., IF, RF, etc.) with terminal 16, or may be integral with respect to terminal 16.

Terminal 16 preferably includes a general purpose or dedicated computer, incorporating electronic processing circuitry (e.g., a processor), memory (e.g., RAM, ROM, magnetic and/or optical memory, etc.), an interface to the input device 14, a display screen or other output device, and a network connection. The network connection can be used to connect to a network 22, such as an intranet, internet, LAN, WAN, wireless network, or other such network, to communicate with at least computers 18 and 20. (Of course, terminal 16 may be a handheld computing device, instead of the computing terminal shown in FIG. 1, such as is disclosed in assignee's U.S. patent application Ser. No. 09/842,282, filed Apr. 24, 2001.).

Suitable software programming instructions, stored in terminal 16's memory, can be used to affect various types of functionality for terminal 16. One such functionality is web browsing (or other communication); another is digital watermark reading.

Returning to FIG. 1, terminal 16 may occasionally communicate with servers (or computers) 18 and 20 (e.g., via a web browser or other communication interface). Computers 18 and 20 maintain and execute software, e.g., for hosting (and/or supporting) web pages, communication, and/or database management, etc. Computers 18 and 20 also maintain suitable software program instructions to help facilitate the system operations described herein. Of course, system 10 may optionally include additional computer sites.

Computer 18 can be referred to as a central server, since it preferably includes a repository or database of unique identifiers. In one embodiment, central server 18 includes a plurality of servers, or a plurality of distributed servers. The identifiers are associated in the database (or data record, table, etc.) with related information, such as URLs, IP addresses, data files, multimedia files, HTML code, XML code, and/or Java applets, etc. The database may be directly associated with server 18, or may be remotely accessed.

Server 20 preferably supports a website or other interface for internet (or other network) access.

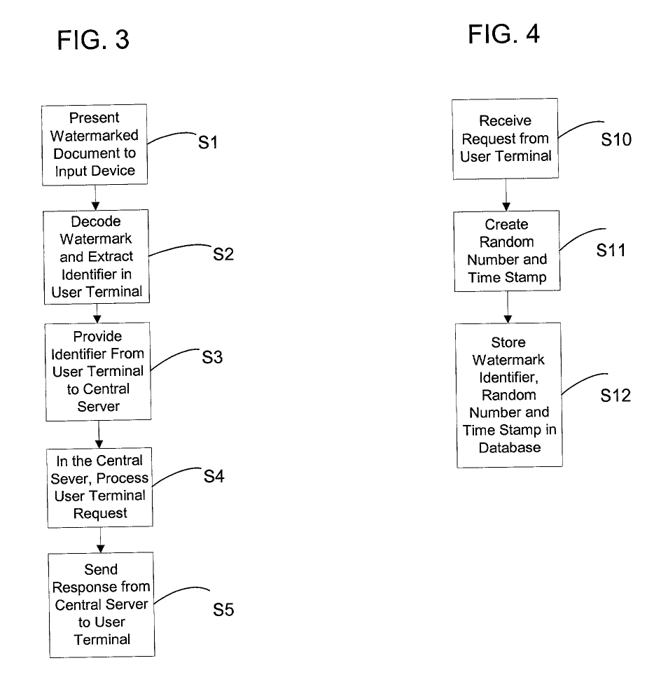

Servers 18 and 20 preferably communicate via a secure, session-oriented internet protocol (“SIP”) connection. This type of connection helps to prevent unauthorized eavesdropping by a third party. In an alternative embodiment, servers 18 and 20 communicate in a non-SIP fashion. In a further embodiment, as shown in FIG. 2, servers 18 and 20 have a dedicated communication path through which communication is carried out.

System Operation

An example is provided as an initial overview of one aspect of the system 10 operation. A more detailed discussion of additional aspects follows. Consider the following example.

A website owner wishes to restrict access to her website. The owner would like to restrict access to only those users who have physical possession of a linking digitally watermarked document. (In this example, a linking watermarked document is one that is used to link, either directly or indirectly, to a website.). A computer and input device scans (or image captures) the digitally watermarked document. A watermark decoder extracts an embedded identifier from the scanned document. The watermark identifier is provided through a network to a central server. The central server identifies a URL associated with the watermark identifier and creates a verification record. The verification record includes a verification key and the identifier. The verification key is provided, along with the URL, to the computer. The computer initiates communication with a website corresponding to the URL, and provides the verification key to the website. The website communicates the verification key and a list of valid watermark identifiers to the central server. The central server then compares the verification key and list of watermark identifiers against the corresponding verification record. If they match, the central server signals the website to allow the computer to access the website. Thus, physical possession of a watermarked document is ensured and/or a user is authorized to access a website.

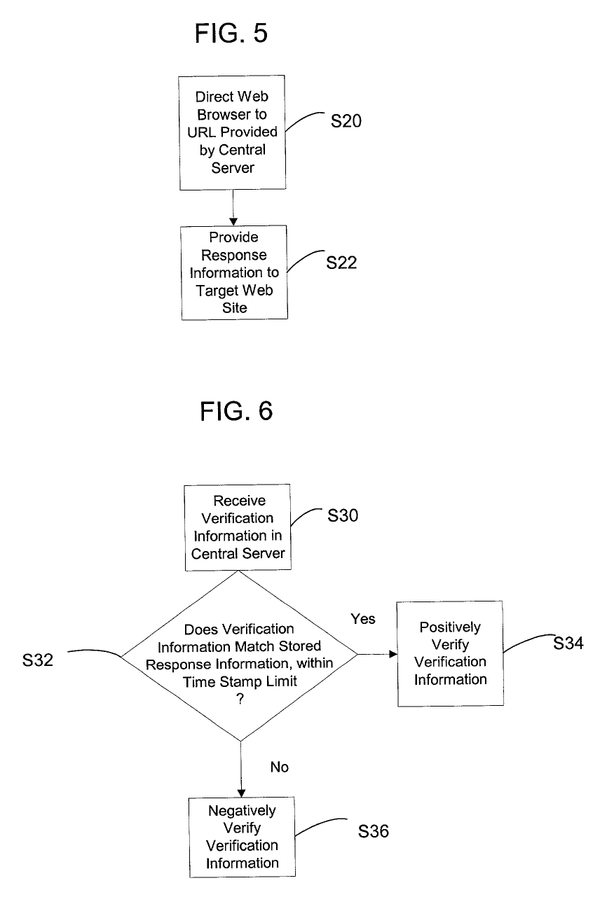

Further aspects of the present invention are now disclosed. With reference to FIGS. 1 and 3, a digitally watermarked document 12 is presented to input device 14 (step S1, FIG. 3). The input device 14 captures an image(s) of the document and conveys such to terminal 16. Executing watermark decoding software instructions (e.g., a “decoder”), terminal 16 decodes the digital watermark embedded within the captured image data and recovers the watermark identifier (step S2). Of course, the decoder may be integrated into various software applications, operating system, web browser, independent software module, device, system, etc. Such a decoder detects and reads an embedded watermark (or watermarks) from a signal suspected of containing the watermark. In one embodiment, the decoder includes Digimarc MediaBridge software, available at www.digmarc.com or through Digimarc Corporation, headquartered in Tualatin, Oregon, U.S.A. Of course, other watermark decoding software may be used in other embodiments.

The extracted watermark identifier (“ID”) is provided from terminal 16 to server 18 (step S3). In one embodiment, the decoder facilitates such communication. In another embodiment, the decoder provides the extracted ID to another software application (communication package, web browser, etc.), which provides the ID to server 18.

At server 18, the ID is processed (step S4). Preferably, such processing includes a step of uniquely identifying a request. Here, a request includes the extracted watermark ID sent to server 18 from terminal 16. FIG. 4 illustrates one such processing method. A request is received in step S10. The request is uniquely identified by generating a random number (step S11). The random number is associated with a corresponding watermark ID and a date/time stamp (step S12). The random number, watermark ID and date/time stamp (referred to generally as a “time stamp”) can be maintained in a database, table, data record and/or in another data structure. Such a table (or database, data record, etc.) is referred to herein generally as a response information table. The time stamp can identify the time of receipt, and/or the processing or response time of the watermark ID. Preferably, the random number is large enough to uniquely identify the request, e.g., 4-256 bits.

Upon receipt of a request, server 18 preferably interrogates its information database to identify any related information, such as a URL or IP address, which is associated with the ID.

Server 18 communicates a response to terminal 16 (step S5, FIG. 3). Typically, a response includes a URL (or IP address). Preferably, the response also includes response information, such as the generated random number and the time stamp.

With reference to FIG. 5, upon receipt of the response, terminal 16's web browser is directed by the URL (or other pointer) provided in the server 18 response (step S20). In one embodiment, the decoder controls (e.g., calls or opens) the web browser and provides the web browser with the URL. In this example, the URL points to server 20's website. In another embodiment, the decoder and web browser are integrated, or the decoder is a web browser plug-in. In still another embodiment, the URL is communicated directly to the web-browser. The response information, or a subset of the response information, is provided from terminal 16 to the target website, e.g., server 20 (step S22). For example, terminal 16 provides the random number and the time stamp to server 20.

With reference to FIG. 1, server 20 communicates with server 18, preferably via a secure, session-oriented internet protocol (“SIP”) connection 24. Server 20 communicates verification information via the SIP connection 24. Such verification information preferably includes the random number, the time stamp and a list of watermark IDs that are valid for the sever 20 website. The list of watermark IDs may include one or more watermark IDs. A valid ID is an ID that is allowed to access the website. (In another embodiment, a valid ID is one that is prohibited from accessing the website.).

With reference to FIG. 6, server 18 receives the verification information in step S30. In step S32, server 18 determines whether the verification information (e.g., the random number and the time stamp) matches any of the entries stored in the response information table (or database, data record, etc.) within a predetermined time period. The random number can be used to index into the response information table. (Alternatively, the list of watermarks IDs is used to interrogate the table to locate associated time stamps and random numbers.). Preferably, the predetermined time period is the most recent 0-15 minutes. More preferably, the predetermined time period is the last 0-60 seconds. A typical response time may be in the range of 45-60 seconds.

If a match is found, a positive response is provided to server 20 (via a website maintained by server 20), e.g., as shown in step S34. Terminal 16 is allowed access to the server 20 website upon receipt of a positive response. If no match is found, a negative response is provided to server 20, e.g., as shown in step S36, and terminal 16 is prohibited from accessing the website.

In another embodiment, upon receipt of a positive verification, server 20 (via the website maintained by server 20) prompts terminal 16 for a PIN or password. Only after a correct PIN or password is received is the user allowed access to the website.

Adding a random number (and optionally, a time stamp) provides enhanced security for linking to websites via a watermark ID. In one case, the random number assists in deterring would-be hackers from making redirection requests, since they must uses a random number matching scheme.

For even further security, a random number can be encrypted. In one embodiment, the user terminal 16, and then server 20, merely passes the encrypted random number back to the server 18, where it is decrypted for verification. In another embodiment, encryption of the random number occurs at terminal 16 using a shared secret stored in the watermark decoder. Terminal 16 is directed to computer 20, and provides server 20 with the encrypted random number. Server 20 passes the encrypted random number to server 18. Server 18 then decrypts the random number using the same-shared secret. This embodiment helps to prevent those who gain knowledge of the watermark ID associated with a particular image from using an application other than an authorized watermark decoder to access the secure web page. Public/Private key encryption is used for even more secure implementations in other embodiments.

A time stamp can also be encrypted. Increased security is even further enhanced by randomly assigning watermark identifiers for related documents. Consider the following example. A series of baseball cards (e.g., 100 cards) are embedded with unique watermark identifiers. Each of the unique identifiers is randomly generated, instead of sequentially identifying the cards. This may help to prevent unauthorized access or copy based attacks on the series of cards, once an identifier or URL is discovered for one or more cards.

Concluding Remarks

The foregoing are just exemplary implementations of an online verification system. It will be recognized that there are a great number of variations on these basic themes. The foregoing illustrates but a few applications of the detailed technology. There are many others.

Consider, for example, the use of embedded watermark data in a document to allow access to a resource. A document may be used to grant physical access through a normally locked door. Or a document may be used to logon to a computer network with directory privileges tied to the data linked to the document.

In some cases, the data encoded in the document fully replicates certain information associated with the document (e.g., the bearer's last name or initials, or OCR printing, or mag-stripe data, etc.). Or the encoded data can be related to other information on the document in a known way (e.g., by a hash function based on the bearer's printed name, or the full-text card contents). Or the encoded data can be unrelated to other information on the card.

In many embodiments, the data encoded in the document may serve as an index to a larger repository of associated data stored in a remote database, e.g., on computer 18. Thus, for example, an index datum read from a passport may allow a passport inspector to access a database record corresponding to the encoded data. This record may include a reference photograph of the passport holder, and other personal and issuance data. If the data obtained from the database does not match the text or photograph included on the card, then the card has apparently been altered.

Instead of a central server generating a random number, a pseudo-random number, coded number, and/or a predetermined number could be generated instead, so long as a request is uniquely identified.

Having described and illustrated the principles of the invention with reference to illustrative embodiments, it should be recognized that the invention is not so limited. In fact, whereas the above embodiments have been described with respect to linking to a URL or website, the present invention is not so limited. The inventive concepts discloses herein can be used to access a locked system, access a restricted file or network areas, or even enter a restricted area. In this case, a user terminal (or security lock) can communicate directly with a central computer, or via a network.

The section headings in this application (e.g., “System Operation”) are provided merely for the reader's convenience, and provide no substantive limitations. Of course, the disclosure under one section heading may be readily combined with the disclosure under another heading.

While the detailed embodiments employ digital watermark technology, other technologies can alternatively be employed. These include barcodes, data glyphs, RFID devices, magnetic stripes, organic transistors, smart cards, etc. Taking as a particular example the document presentment concept, much the same functionality can be obtained by providing an RFID device in a document, and providing an RFID sensor at a user's computer (e.g., in a mouse pad).

To provide a comprehensive disclosure without unduly lengthening this specification, the above-mentioned patent and patent applications are hereby incorporated by reference. The particular combinations of elements and features in the above-detailed embodiments are exemplary only; the interchanging and substitution of these teachings with other teachings in this application and the incorporated-by-reference patent/applications are also contemplated.

The above-described methods and functionality can be facilitated with computer executable software stored on computer readable mediums, such as electronic memory circuits, RAM, ROM, magnetic media, optical media, removable media, etc. Such software may be stored on a user terminal, and/or distributed throughout a network. Data structures representing the various data structures (tables, data records, databases, etc.) may also be stored on such computer readable mediums. Also, instead of software, a hardware implementation can be used.

In view of the wide variety of embodiments to which the principles and features discussed above can be applied, it should be apparent that the detailed embodiments are illustrative only and should not be taken as limiting the scope of the invention. Rather, we claim as our invention all such modifications as may come within the scope and spirit of the following claims and equivalents thereof.

What is claimed is:

1. A method of regulating access to a website by a user terminal via the internet, the user terminal reading a document including an embedded digital watermark, said method comprising the steps of:
at the user terminal, extracting identifying data from the digital watermark, and providing the identifying data to a central computer;
at the central computer:
identifying a pointer associated with the identifying data;
generating at least one component of response information;
storing the response information; and
providing the pointer and response information to the user terminal;
at the user terminal, communicating with the website via the pointer and providing the response information to the website;
at the website, communicating verification information to the central computer; and
at the central computer, verifying authority to access the website based at least in part on a comparison of the verification information and the stored response information.

2. The method according to claim 1, wherein the identifying data comprises a document identifier.

3. The method according to claim 2, wherein the pointer comprises at least one of a URL, IP address and web address.

4. The method according to claim 2, wherein the at least one component comprises a random number.

5. The method according to claim 4, wherein said generating step further comprises the step of generating at least a second component, the second component comprising a time stamp.

6. The method according to claim 2, wherein the response information comprises at least the random number and the time stamp.

7. The method according to claim 6, wherein the verification information comprises at least the random number, the time stamp and a valid identifier.

8. The method according to claim 7, wherein said verifying authority step comprises the steps of indexing the stored response information via the communicated random number and determining whether the stored document identifier matches the valid identifier and whether the verification information is received within a predetermined time period.

9. The method according to claim 8, wherein when the stored document identifier matches the valid identifier within the predetermined time period, said method further comprising the step of authorizing user terminal access to the website.

10. The method according to claim 8, wherein when the stored document identifier does not match the valid identifier or the verification information is not received within the predetermined time period, said method further comprises the step of signaling a lack of authority for the user terminal to access the website.

11. The method according to claim 7, wherein said verifying authority step comprises the steps of indexing the stored response information via the valid identifier and determining whether the stored random number matches the communicated random number, and whether the verification information is received within a predetermined time period.

12. The method according to claim 1, further comprising the step of encrypting at least one component of the of the response information.

13. The method according to claim 2, wherein the document identifier is randomly generated.

14. A method of authenticating permission to access a system comprising the steps of:
receiving a request to enter the system, the request including at least a verification key;
querying a data structure to determine whether the verification key is authorized; and
allowing access to the system based on the response to the query.

15. The method according to claim 14, wherein said system comprises a website.

16. The method according to claim 15, wherein said receiving step comprises a user terminal signaling the website.

17. The method according to claim 14, wherein the verification key comprises a first random number, and the data structure comprises at least one data record including a second random number and a first identifier.

18. The method according to claim 17, wherein the verification key further comprises a first time stamp and the data record further includes a second time stamp.

19. The method according to claim 18, wherein said system communicates the first random number and a second identifier to the data structure, and wherein said data structure:
indexes the data record via the first random number, the first and second random numbers being equal,
determines whether the first identifier matches the second identifier, and whether the first time stamp is within a predetermined time range based on the second time stamp, and
signals to the system whether the first identifier matches the second identifier and whether the first time stamp is within the predetermined time range.

20. The method according to claim 17, wherein the first identifier comprises an identifier extracted from a digital watermark.

21. The method according to claim 17, wherein said system communicates the a second identifier and the first random number to the data structure, and wherein said data structure:
indexes the data record via the second identifier, the first identifier and second identifier being equal,
determines whether the first random number matches the second random number, and
signals to the system whether the first random number matches the second random number and whether the verification information is received within a predetermined time.

22. A system for exchanging data comprising:
a central server comprising at least one database including response information and pointer information, wherein when a user terminal communicates an extracted watermark identifier to said central server, said central server identifies a corresponding URL with the extracted watermark identifier, and wherein said central server generates a number, and stores the number and extracted watermark identifier in the database as response information.

23. The system according to claim 22, wherein said at least one database comprises a first database for storing pointers and a second database for storing response information.

24. The system according to claim 22, wherein said server further generates a time stamp and stores the time stamp with the response information.

25. The system according to claim 22, wherein the number comprises at least one of a random number, a pseudo-random number, and a predetermined number.

26. A method of operating a computer server, the computer server to communicate with at least one user terminal, said method comprising the steps of:
receiving a document identifier from the user terminal;
identifying a pointer associated with the document identifier;
generating at least one component of response information;
storing the response information; and
providing the pointer and response information to the user terminal.

27. The method according to claim 26, wherein the document identifier comprises an identifier embedded in the form of a digital watermark.

28. The method according to claim 27, wherein the pointer comprises at least one of a URL, IP address and web address.

29. The method according to claim 27, wherein the at least one component comprises a random number.

30. The method according to claim 29, wherein the response information further comprises a time stamp.

31. The method according to claim 26, wherein the response information comprises at least a random number and a time stamp.

32. The method according to claim 31, further comprising a step of verifying data, wherein said verifying data step comprises the steps of indexing the stored response information via a second random number, and determining whether the stored document identifier matches a valid identifier.

33. The method according to claim 32, wherein when the stored document identifier matches the valid identifier, said method further comprises the step of authorizing user terminal access.

34. The method according to claim 32, wherein when the stored document identifier does not match a valid identifier, said method further comprises the step of signaling a lack of authority for the user terminal.

35. The method according to claim 31, wherein said verifying data step comprises the steps of indexing the stored response information via a valid identifier and determining whether the stored random number matches a second random number.

36. The method according to claim 31, further comprising the step of encrypting at least one component of the response information.

37. The method according to claim 31, wherein the document identifier is randomly generated.

38. A data record stored on a computer readable medium, said data record comprising a watermark identifier, a randomly generated number, and a time stamp.
